(19) United States
(12) Patent Application Publication
(10) Pub. No.: US 2004/0118204 A1
(43) Pub. Date: Jun. 24, 2004

(54) Vibratory gyroscopic rate sensor

(76) Inventors: Christian P Fell, Plymouth (GB); Rebecka Eley, Plymouth (GB); Colin H J Fox, Nottingham (GB)

Correspondence Address: NIXON & VANDERHYE, PC, 1100 N GLEBE ROAD, 8TH FLOOR, ARLINGTON, VA, 22201-4714, US

(21) Appl. No.: 10/475,003

(22) PCT Filed: Sep. 6, 2002
(86) PCT No.: PCT/GB02/04053

(30) Foreign Application Priority Data
Sep. 14, 2001 (GB) 0122252.0

(51) Int. Cl. G01P 3/44

(52) U.S. Cl. 73/504.13

(57) ABSTRACT

A single axis rate sensor (10) including a substantially planar vibratory resonator (16) having a substantially ring or hoop-like structure with inner (24) and outer peripheries extending around a common axis, drive means (18) for causing the resonator to vibrate in a Cosθ vibration mode, carrier mode pick-off means (20) for sensing movement of the resonator in response to said drive means (18), pick-off means (36) for sensing resonator movement induced in response to rotation of the rate sensor about the sensitive axis, drive means (38) for mulling said motion, and support means (22) for flexibly supporting the resonator (16) and for allowing the resonator (16) to vibrate relative to the support means (22) in response to the drive means, and to applied rotation wherein the support means (16) comprises only L support beams, where L≠3×2^{K-1}, L>2 and K=1, 2 or 3.

This invention relates to rate sensors for sensing applied rate on one axis.

Rate sensors such as vibrating structure gyroscopes are known which have been constructed using a variety of different structures. These structures include beams, tuning forks, cylinders, hemispherical shells and rings. A common feature in all of these designs is that they maintain a resonant carrier mode oscillation. This provides the linear momentum which produces a Coriolis force when the gyroscope is rotated around the appropriate axis.

It has been proposed to enhance the sensitivity of these devices by matching the resonant frequencies of the carrier and response modes. With these frequencies accurately matched the amplitude of the response mode vibration is amplified by the mechanical quality factor, Q, of the structure. This inevitably makes the construction tolerances more stringent. In practice, it may be necessary to fine-tune the balance of the vibrating structure or resonator by adding or removing material at appropriate points, for example as described in GB-A-2292606 which relates to planar ring structures. This adjusts the stiffness of mass parameters for the modes and thus differentially shifts the mode frequencies. Where these frequencies are not matched the Q amplification does not occur and the pick-offs must be made sufficiently sensitive to provide adequate gyroscope performance.

For a perfectly symmetric resonator in the form of a ring two degenerate vibration modes will exist. One of these modes is excited as the carrier mode. All of the vibration occurs in the plane of the ring. When the structure is rotated about the axis normal to the plane of the ring (z-axis) Coriolis forces couple energy into the response mode. The resonator structure is actually in motion both radially and tangentially. Usually, only radial motion is detected. With no applied rate there will be no response mode motion. When the device is rotated about the z-axis Coriolis forces are generated around the ring which set the degenerate vibration mode into oscillation. The resulting amplitude of motion is proportional to the rotation rate.

Enhanced sensitivity may be obtained if the carrier and response mode frequencies are accurately balanced. Choosing a material with radially isotropic properties is of great benefit in achieving this balance. Additional post manufacture fine-tuning may still be required to achieve the desired accuracy, however.

The use of ring shaped resonators in single axis Coriolis rate sensors which make use of degenerate Cos3θ modes is known. As example of such a device is described in GB 0001775.6. This device makes use of the two degenerate Cos3θ modes

In all of the example devices the carrier and response mode frequencies are required to be nominally identical. The leg structures supporting these ring structures have the effect of individual spring masses acting at the point of attachment to the ring. As such, they will locally alter the mass and stiffness hence shifting the mode frequencies. The number and location of these supports must be such that the dynamics of the carrier and response modes are not differentially perturbed. For an appropriate configuration of support legs, for single axis Cos3θ devices, while both mode frequencies will be shifted, they will be changed by an equal amount and no frequency split will be introduced. The number of support legs hitherto thought to be required to achieve this is equal to 4n, where n is the number of nodal diameters (n=3 for Cos3θ modes), with the angular separation given by 90°/n.

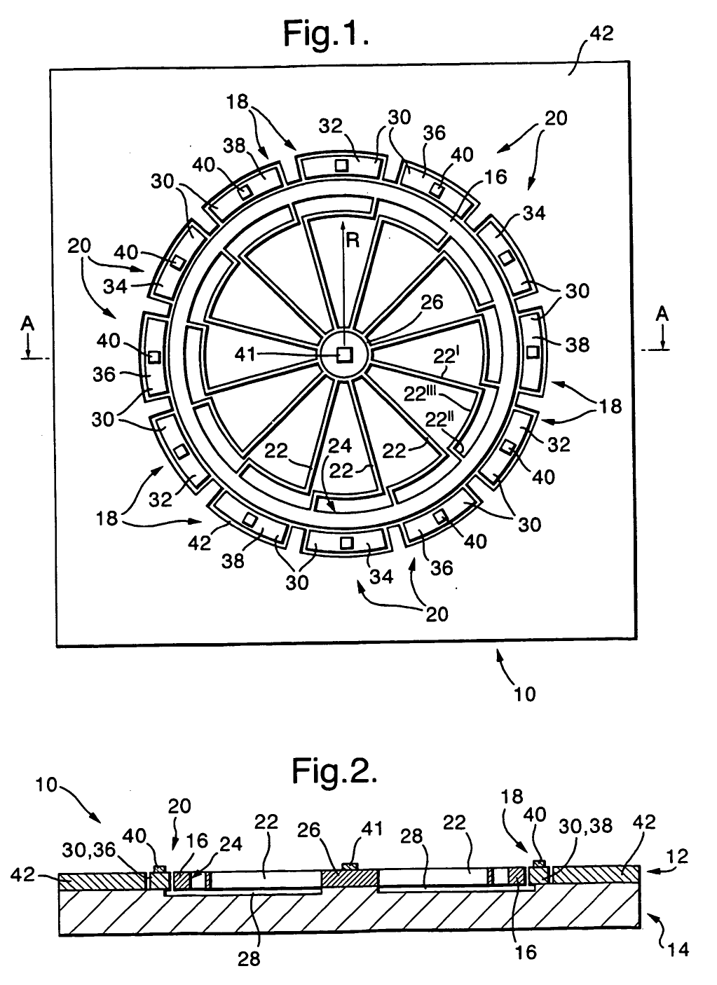

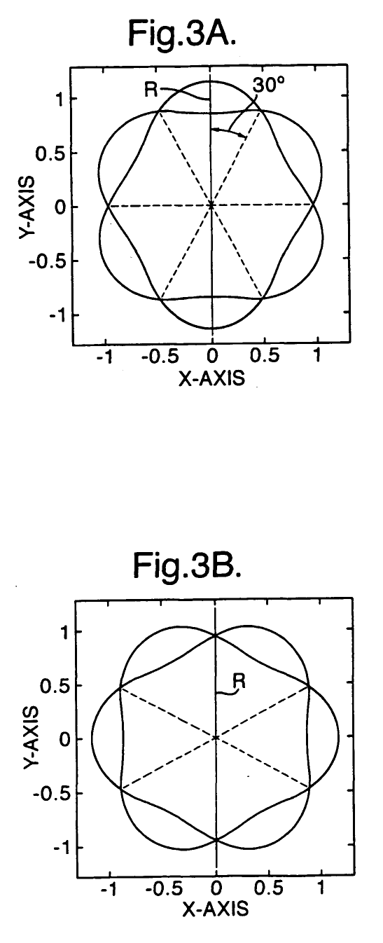

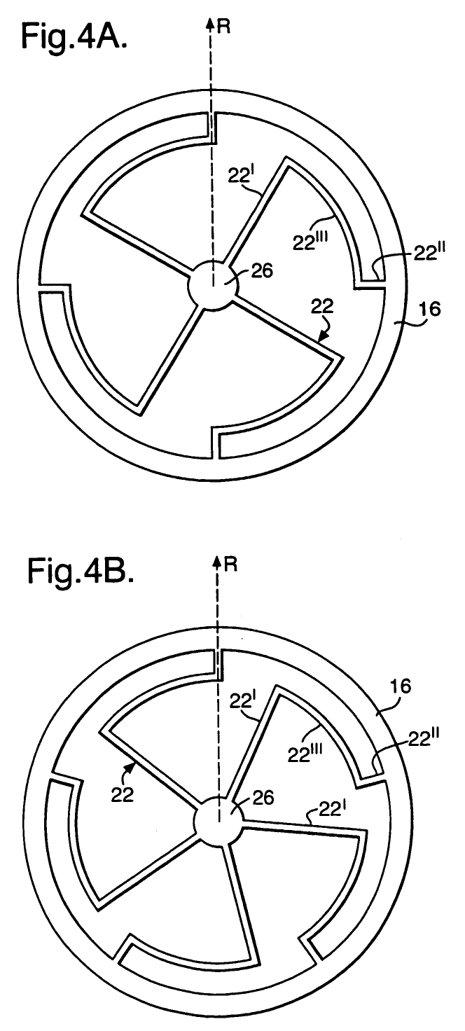

When using a Cos3θ vibration mode pair, twelve support legs (=4n where n=3), at an angular spacing of 30°, would typically be employed, as shown in the present applicants co-pending application GB 0001775.6. These leg structures are required to suspend the ring but must also allow it to vibrate in an essentially undamped oscillation. FIG. 1 shows such an arrangement. In this arrangement a central boss 26 is formed on the support frame 14. Support legs 9 extend between a central boss 26 and the inner periphery 24 of a resonator 16. It will be noted that the relative lengths of the linear parts 22′ and 22″ of the support legs are different in FIG. 3, and this is part of the normal design variation that would be understood by a person skilled in the art.

Also it will be understood that the provision of a central boss 26 in FIG. 1 is a known alternative to radial external support for the resonator 16. These arrangements are interchangeable, irrespective of the number of support legs being used.

For devices such as these, the radial and tangential stiffness of the legs should be significantly lower than that of the ring itself so that the modal vibration is dominated by the ring structure. The radial stiffness is largely determined by the length of the arcuate segment 22′″ of the leg. The straight segments 22′ and 22″ of the leg dominates the tangential stiffness. Maintaining the ring to leg compliance ratio, particularly for the radial stiffness, for this design of leg becomes increasingly difficult as the arc angle of the leg structure is restricted by the proximity of the adjacent legs. This requirement places onerous restrictions on the mechanical design of the support legs and necessitates the use of leg structures which are thin (in the plane of the ring) in comparison to the ring rim. This reduced dimension renders these structures more susceptible to the effects of dimensional tolerancing in the production processes of the mechanical structure. This will result in variation in the mass and stiffness of these supporting leg elements which will disturb the symmetry of the mode dynamics and hence induce frequency splitting between the Cos3θ vibration mode pair.

The structures described in the prior art may be fabricated in a variety of materials using a number of processes. Where such devices are fabricated from metal these may be conveniently machined to high precision using wire erosion techniques to achieve the accurate dimensional tolerancing required. This process involves sequentially machining away material around the edges of each leg and the ring structure. The machining time, and hence production cost, increases in proportion to the number of legs. Minimising the number of legs is therefore highly beneficial. Similar considerations apply to structures fabricated from other materials using alternative processes.

It would be desirable to be able to design planar ring structures which require a reduced number of support legs but without affecting the vibration of the ring structure to any greater extent from the prior art arrangements having a relatively large number of support legs.

According to a first aspect of the present invention, there is provided a single axis rate sensor including a substantially planar vibratory resonator having a substantially ring or hoop-like structure with inner and outer peripheries extending around a common axis, drive means for causing the resonator to vibrate in a Cos3θ vibration mode, carrier mode pick-off means for sensing movement of the resonator in response to said drive means, pick-off means for sensing resonator movement induced in response to rotation of the rate sensor about the sensitive axis, drive means for nulling said motion, and support means for flexibly supporting the resonator and for allowing the resonator to vibrate relative to the support means in response to the drive means and to applied rotation wherein the support means comprises only L support beams, where L≠3×2^{K-1}, L>2 and K=1, 2 or 3. For example, there may be four, five or seven support beams.

Preferably, there are fewer than twelve support beams, as this simplifies the manufacturing process.

Each support beam may comprise first and second linear portions extending from opposite ends of an arcuate portion.

In the embodiment, the support beams are substantially equi-angularly spaced.

Conveniently, the support means includes a base having a projecting boss, with the inner periphery of the substantially ring or hoop-like structure being coupled to the boss by the support beams which extend from the inner periphery of the ring or hoop-like structure to the projecting boss so that the ring or hoop-like structure is spaced from the base.

In the embodiment, the total stiffness of the support beams is less than that of the ring or hoop-like structure.

The formulae defined above have been obtained as a result of a detailed analysis of the dynamics of the ring or hoop-like structure including the effects of leg motion. The present invention may provide increased design flexibility allowing greater leg compliance (relative to the ring) whilst employing increased leg dimensions (in the plane of the ring). Such designs may exhibit reduced sensitivity to dimensional tolerancing effects and allow more economical fabrication.

For a better understanding of the present invention, and to show how the same may be carried into effect, reference will now be made, by way of example, to the accompanying drawings, in which:

FIG. 1 is a plan view of a vibrating structure gyroscope having twelve support legs, not according to the present invention.

FIG. 2 is an edge view of the embodiment of FIG. 1.

FIGS. 3A and 3B show two degenerate Cos3θ modes in a symmetric resonator or vibrating structure acting as a carrier mode;

FIGS. 4A and 4B show a plan view of a vibrating structure gyroscope according to the present invention having four and five support legs, respectively

An angular rate sensor device according to the prior art is now described with reference to FIGS. 1 and 2. The sensor device 10 comprises a micro-machined vibrating structure gyroscope and is arranged to operate with a Sin3θ and Cos3θ vibration mode pair as has been described previously. More specifically, the cos3θ carrier and Sin3θ response mode patterns are shown in FIGS. 3A and 3B.

The device 10 utilising these modes incorporates electrostatic drive transducers and capacitive forcing transducers similar to those described in the present applications co-pending GB 9817347.9. The fabrication processes used to produce this structure are essentially the same as those described in the present applicants co-pending GB 9828478.9 and, accordingly, are not described hereinafter in any further detail.

The device 10 as shown in FIGS. 1 and 2, is formed from a layer 12 of [100] conductive Silicon anodically bonded to a glass substrate 14. The main located at 0°, 120°, and 240° to a fixed reference axis R, are used as carrier drive elements 32. The carrier mode motion is detected using the plates 30 at 60°, 180° and 300° to the fixed reference axis R, as pick-off transducers 34. Under rotation Coriolis forces will couple energy into the response mode. This motion is detected by response mode pick-off transducers 36 located at 30°, 150° and 270° to the fixed reference axis R. To allow the device 10 to operate in a force feedback mode response mode, drive elements 38 are located at 90°, 210° and 330° to the fixed reference axis R. Electrical bond pads 40 are provided on each drive and pick-off transducer 18, 20 to allow for connection to control circuitry (not shown).

In operation a drive voltage is applied to the carrier drive elements 32 at the resonant frequency. The ring structure resonator 16 is maintained at a fixed offset voltage which results in a developed force which is linear with the applied voltage for small capacitor gap displacements. Electrical connection to the ring structure resonator 16 is made by means of a bond pad 41 provided on the central hub 26 which connects through the conductive silicon of the legs 22 to the ring structure resonator 16. The induced motion causes a variation in the capacitor gap separation of the carrier mode pick-off transducers 34. This will generate a current across the gap which may be amplified to give a signal proportional to the motion. The rotation induced motion at the response mode pick-off transducers 36 is similarly detected. In force feedback mode, a drive voltage is applied to the response mode drive transducers 38 to null this motion with the applied drive voltage being directly proportional to the rotation rate. Direct capacitive coupling of the drive signals onto the pick-off transducers 20, 34, 36 can give rise to spurious signal outputs which will appear as a bias output and degrade the drive performance. In order to minimise this error, a screen layer 42 is provided which surrounds the capacitor plates 30 on all sides except that facing the ring structure resonator 16. This screen 42 is connected to a ground potential which enables the drive and pick-off transducers 18, 20 to be in close proximity to one another.

A detailed analysis of the dynamics of the ring including the effects of the leg motion has enabled simple formulae to be developed which prescribe the range of options available in terms of the number of substantially evenly spaced support legs required to maintain frequency matching of the desired vibration mode pairs.

The analysis indicates that the requirement on the number of legs is far less restrictive than previously indicated. Simple formulae have been derived indicating which modes will have their frequency split for a given number of evenly spaced support legs. These formulae are generally applicable to both in plane and out of plane CosNθ odes where N is the mode order and are valid for L>2. If L≦2 then all modes will be split. For an even number of legs, L, frequency splitting for a mode of order N will only occur when the following condition is met:

$$N = \frac{LK}{2}$$

where K is an integer. Maximum frequency splitting occurs when K=1 and reduces as K is increased. If the number of legs, L, is odd then frequency splitting will only occur where:

N=LK

The maximum splitting again occurs for K=1 and decreases as the value of K increases.

Applying these general principles to the single axis planar ring resonator design of the prior art, employing Cos3θ modes, leads to the conclusion that the number of support legs is no longer restricted to twelve. Planar ring resonators with support leg structures conforming to the following formula, may be constructed:

L≠N×2^{K-1}

where N is the mode order (=3 for Cos3θ modes) and K is an integer of value 1, 2 or 3. The legs should be equi-angularly spaced. Support structures consisting of four legs at 90° spacing, five legs at 72° spacing etc. such as shown in FIGS. 4A and 4B, which preserve the required mode frequency matching and are suitable for use in Coriolis rate sensors, may therefore be utilised. Although providing twelve or more legs may preserve mode frequency matching, providing a reduced number of legs is advantageous for the reasons discussed above.

In all resonator designs the combined stiffness of the support legs is required to less than that of the ring. This ensures that the modal vibration is dominated by the ring structure and helps to isolate the resonator from the effects of thermally induced stresses coupling in via the hub 20 of the structure, which will adversely affect performance. When employing fewer support legs the required leg to ring compliance ratio may be maintained by using longer support leg structures of increased width. This renders these structures less susceptible to the effects of dimensional tolerancing errors arising during the fabrication process. Such errors induce frequency splitting between the Sin3θ and Cos3θ modes, which is detrimental to the sensor performance. This typically necessitates the use of mechanical trimming procedures to achieve the desired performance levels. Reducing the requirement for this trimming procedure is therefore highly desirable in terms of cost and fabrication time.

1. A single axis rate sensor including a substantially planar vibratory resonator having a substantially ring or hoop-like structure with inner and outer peripheries extending around a common axis, drive means for causing the resonator to vibrate in a Cos3θ vibration mode, carrier mode pick-off means for sensing movement of the resonator in response to said drive means, pick-off means for sensing resonator movement induced in response to rotation of the rate sensor about the sensitive axis, drive means for mulling said motion, and support means for flexibly supporting the resonator and for allowing the resonator to vibrate relative to the support means in response to the drive means and to applied rotation wherein the support means comprises only L support beams,
where L≠3×K^{K-1}, L>2 and K=1, 2 or 3.

2. A rate sensor according to claim 1, wherein L<12.

3. A rate sensor according to claim 1 or claim 2, wherein each support beam comprises first and second linear portions extending from opposite ends of an arcuate portion.

4. A rate sensor according to any one of the preceding claims, wherein the support beams are substantially equi-angularly spaced.

5. A rate sensor according to any one of the preceding claims, wherein the support means includes a base having a projecting boss, with the inner periphery of the substantially ring or hoop-like structure being coupled to the boss by the support beams which extend from said inner periphery of the ring or hoop-like structure to the projecting boss so that the ring or hoop-like structure is spaced from the base.

6. A rate sensor according to any one of the preceding claims wherein the total stiffness of the support beams is less than that of the ring or hoop-like structure.

7. A rate sensor substantially as hereinbefore described with reference to and/or substantially as illustrated in FIGS. 4A or 4B of the accompanying drawings.
